(19) United States
(12) Patent Application Publication
(10) Pub. No.: US 2016/0148311 A1
(43) Pub. Date: May 26, 2016

(54) METHOD AND SYSTEM FOR PROVIDING INFORMATION ON LOAN TRANSACTION, SHORT SELL TRANSACTION OR EQUITY SWAP TRANSACTION, AND NONTEMPORARY COMPUTER-READABLE RECORDING MEDIUM

(71) Applicant: Eugene Maeng KIM, New York, NY (US)

(72) Inventor: Eugene Maeng KIM, New York, NY (US)

(21) Appl. No.: 14/890,742

(22) PCT Filed: May 13, 2014
(86) PCT No.: PCT/KR2014/004264

§ 371 Date: Nov. 12, 2015

(30) Foreign Application Priority Data
May 13, 2013 (KR) 10-2013-0054020

(51) Int. Cl. G06Q 40/04; G06Q 40/02

(52) U.S. Cl. CPC G06Q 40/04; G06Q 40/025

(57) ABSTRACT

According to one aspect of the present invention, provided is a method for proving information on a loan transaction, a short sell transaction or an equity swap transaction, and the method generates information related to at least one among a true outstanding loan, a true borrow cost, true utilization, true short interests, true days to cover, and true availability with respect to securities.

### FIELDS OF TECHNOLOGY

This invention is about a method/system and non-transitory computer-readable recording medium for providing information on providing information on loan transaction, short sell transaction or equity swap transaction.

### BACKGROUND TECHNOLOGY

A Securities Lending & Borrowing Transaction (“LBT”) means a contract formed where a lender promises to transfer the ownership of certain securities and a borrower promises to return the same quantities of those securities in the future. Once a Securities LBT is formed, right to dispose of and right to profit from those securities are transferred to the borrower, and in consideration of these rights, the lender is compensated by the borrower with economic benefit the lender could have received if he or she had not executed the LBT, such as cash dividends, bonus shares, rights issue, or coupon payments on bonds.

LBT is used to accomplish various purposes including: short selling of borrowed securities in order to hedge against different types of financial risk; arbitrage transaction through short selling; hedging equity swap through short selling; collateral usage; fail coverage; recall coverage; refinancing at a lower rate; and replacement of existing LBT with more stable supply.

Meanwhile, short selling refers to a transaction where an investor directly borrows a share and sells the share under his/her ownership, which also can be replicated through equity swap, a derivative transaction. Here, equity swap is a derivative transaction which can be classified as long swap and short swap: the effect of which is similar to that of buying, selling, or short selling and can be accomplished by the equity swap holders without directly trading the underlying securities. Thus, equity swap holders generally take market risk equivalent to that of trading the underlying securities. The equity swaps may be called delta one products as they generally have a delta, an indicator of the ratio of the price movement of the derivative assets relative to that of the underlying assets, of 1, because the price volatility of the equity swap equals to the volatility of its underlying securities (or a basket of various securities). In case of long swap, if the price of underlying securities goes up/down, the swap holder makes equivalent profit/loss. Short swap has profit/loss mechanism opposite to that for long swap.

Despite the sharp increase in LBT, short selling or equity swap for the past several years, it has not been easy to figure out the volume and market situation of those transactions. Financial regulatory authorities, securities exchanges, and various information providers have attempted to figure out part of information on LBT and short selling, not including equity swap, and made disclosure when necessary, for the purpose of enhancing the transparency of the transaction.

However, the said disclosure had following problems or limits:

1. It is difficult to find out the True Outstanding Loan (borrowed securities for the purpose of short selling) as well as True Borrow Cost (or rate) and True Borrow Utilization, which can be derived based on the True Outstanding Loan.

2. It is difficult to find out the True Short Interest (outstanding volume of short selling transactions and/or the transactions with equivalent effect) as well as True Days to Cover which can be derived based on the True Short Interest.

3. It is difficult to figure out the True Availability (rather than the rough estimate) of the securities that can actually be borrowed or lent.

4. It is difficult to find out the True Recall and True Rate Change Information in the whole market.

5. It is not possible to find out the True Swap Transactions & Outstanding balance that include the balance of all long and short of equity swaps, which trade in the form of derivatives products.

6. It is not possible to find out statistical data on the Locate Number or ID of the whole market, which can corroborate the ownership of the shares (that these are already borrowed or the borrow contract is made), so that True Locate Approvals or ID Issued can be figured out.

7. There is no information on: collateral types and rates of all LBTs (both onshore and offshore) in the market; rebate (in case of cash collaterals); True Collateral Pledged, providing information on intermediaries managing collaterals.

8. It is difficult to find out information on True Intermediary Transactions Summary, which integrates all transactions that went through the intermediaries.

The details of the abovementioned problems and limits were discussed as follows.

As aforementioned, the securities traded by participants of borrowing and lending transactions can be used for short selling as well as various other purposes. There are cases where the transaction does not involve short selling, that is, where the borrowed securities are not used for short selling (e.g. financing trades where collaterals are provided through LBT for obtaining finance; on-lending which re-lends the borrowed securities to other borrowers; LBT for providing collaterals, etc.). In such cases, the securities not connected with short selling have been included in calculating the total volume of the LBTs in the market, which are provided by the current financial regulatory authorities, securities exchanges, and various information providers, making it difficult to figure out the balance of the True Outstanding Loan, which refers to the securities for LBTs directly connected to short selling.

Also, through the existing estimate for outstanding loans, it is difficult to figure out the True Borrow Cost (or rate) and True Borrow Utilization, which is based on True Outstanding Loans. True Borrow Cost means the average lending and borrowing rate for True Outstanding Loans; and True Borrow Utilization is calculated by dividing True Outstanding Loan by True Availability. Through the existing estimate for the outstanding loan, it is difficult to figure out such statistics, and thus, one cannot figure out lending and borrowing rate as well as utilization, directly related to short selling.

Among equity swaps mentioned above, a short swap refers to a transaction which has the same effect as short selling: investors can have the same profit mechanism as short selling without the hassle of actually borrowing and short selling securities by executing short swap transaction with a broker. Brokerage firms (or broker-dealers) that provide equity swap products sell the swap products while short selling or long selling (in case their net asset is positive) the underlying securities in order to hedge the risk of providing the swap product. Where a broker (swap provider) has a net asset that is positive, the swap provider may hedge its position by long selling the share: on this occasion, it is difficult to generate statistics on True Short Interest, that is, total outstanding transactions which has the same effect as the amount short sold and the amount both sold short and long for hedging short swap transactions. Here, short interest refers to total short sell balance in the market: more specifically, it refers to the amount on which the short covering was not made as of the settlement date following the execution of short sale. Generally, the larger the amount of short interest gets, the higher the demand on the borrow for short sale and occasionally the higher the expectation of the price falling. True Short Interest, the aggregate outstanding transaction amount that has same effect as short sales, does not exist in the market although there is an estimate for the short interest derived from estimated outstanding loan balance or the net short position required to be reported to the regulatory authority or securities exchange.

Also, it is difficult to figure out True Days to Cover, calculated by dividing balance of True Short Interest by average trading volume (e.g. daily average for the past 20 days), due to insufficient information available on SI. The True Days to Cover is represented as a certain length of days (e.g. 3.5 days), and this indicates how many days it takes to cover the amount of short sale outstanding as well as how much securities are short sold compared to the daily trading volume. Accordingly, it is impossible to figure out exact information on the True Days to Cover even though it plays an important role as a reference that indicates the outstanding volume of short sale transaction that are not covered yet.

Also, the lending of securities is mainly conducted by onshore/offshore asset management companies, securities companies who have net long assets, pension funds, or securities companies with retail pools; however, it is impossible to figure out the availability of the whole onshore/offshore market because only each participant's estimate for the availability of certain securities has existed. The estimate for the availability of the whole market has been derived by using only a portion of data. Because securities companies are often reluctant to disclose the information on their net asset exposure and the size of their retail pools, and often overstate their availability for their marketing purpose, the information on securities that can be lent is not accurate. Also, attributes of shares to be lent, such as stability or corporate action, differ depending on the sources and features, thus making it difficult to estimate true availability of the aggregate amount of securities that can be lent classified by their attributes.

Meanwhile, information on recalls and rate changes is important in lending and borrowing as well as short sell transactions. Recalls (that is, request for return) or rate increases usually indicate that demand for lending and borrowing transactions may have increased (where the opposite is indicated when there is rate decreases), which is very significant information for participants of lending and borrowing or short sale transactions. In particular, as a borrower may have to short cover and return the borrowed securities regardless of their intention even in the case of the borrow rate rising, information on recalls and rate changes is very significant information for participants of lending and borrowing, short sale or equity swaps (especially, short swaps) transactions. Although the information on recalls and rate changes is held by the participants involved in those recalls or rate changes, or recorded by intermediaries of those lending and borrowing transactions, there is no statistics on the requests on recalls or rate changes made in the whole market. Accordingly, market participants can only get estimates by asking several borrowers or lenders about the recalls and rate changes, which makes it difficult for them to make an informed investment decision.

In addition, in case of equity swaps traded in the form of a derivatives product, there is no way to obtain information on long swaps not to mention short swaps as aforementioned. Accordingly, market participants cannot obtain information on either trading volume per each equity swap or volume traded by broker-dealers in order to hedge their swap products. Information on long/short swap is an important indicator for understanding investment trend among hedge funds: the information signals when to buy and sell as well as enhances transparency in trading derivatives products. As no information on equity swap trading in the market is reported, there is a need for a system that can provide information on the outstanding equity swaps that are not unwound.

Meanwhile, all the participants of short sales should prove that they own (have borrowed or confirmed the contract to borrow) the shares, which can be identified by locate approvals (locate number or ID), unique serial numbers assigned to the confirmed borrow contract. Locate ID is generated prior to short sale order is made and thus it can be an important indicator for estimating the demand for short sales even though the investor does not ultimately complete the short sale transaction. However, no statistics on locate IDs for the whole market can be found.

Also, collaterals such as shares, bonds, or cash are provided by borrowers to lenders for the LBT most of the times, in order for the lenders to decrease the counterparty credit risk against the borrowers. Here, no information exists on True Collateral Pledged such as collateral types and rates of all LBTs, rebate (in case of cash collaterals) from a lender to a borrower, and collateral related transactions conducted through collateral management agencies or intermediaries, so it is difficult to figure out what kind of securities or cash is more utilized in the market or which of the securities have more utilization value.

More specifically, following examples show existing disclosure method for information on LBTs or short sales.

Firstly, in accordance with law and regulation of each nation, market participants may have obligation to report the LBT balance or short sale balance to the regulatory authorities or securities exchanges: these authorities or securities may disclose the statistics gathered from the participants selectively, and based on the statistical information, they may choose to restrain trading short sales of any individual shares or all the listed shares temporarily if they see the market being unstable.

Secondly, securities exchanges in some countries gather and disclose daily trading volume of short sales, which enables the market participants to figure out short sell trading volume by individual share or by indices.

Thirdly, existing systems such as Markit Data Explorers, Equilend, Datalend, Sungard's Lendingpit gather, aggregate and disclose data on availability of LBT and balance of securities already borrowed/lent from some of the participants of the LBT. Also, Bloomberg Terminal discloses the existing information on balance of lending and borrowing received from Markit Data Explorers as well as trading volume of short sales disclosed at securities exchanges.

But, these disclosures do not overcome limits or problems aforementioned.

First of all, it is difficult to figure out true short interest including transactions that have the same effect as short sales because each country has different definition, calculation method, or reporting standards on the outstanding LBT or short sale balance.

Next, the second method is problematic because it is impossible to gain relevant information in case where a broker with net long position hedges the position by long selling rather than short selling: securities exchange does not include volume of long sell transactions into the statistics, thus it is difficult to figure out short interest including all relevant transactions equivalent to short selling.

Next, the third method also is difficult to lead to True Outstanding Loans that are directly relevant to the short selling because the figure does not exclude transactions not directly related to short selling, such as financing transactions that involve receipt of securities as collateral for lending cash or delivery of securities as collateral for borrowing cash. Accordingly, there has been confusion in the market as there is a significant difference between the figure disclosed by Markit Data Explorers, Equilend, or Sungard and True Short Interest that is directly related to the short selling activity.

Also, as the figure disclosed by the systems above merely integrates the volume of securities that can be lent or LBT balance gathered from some of the offshore participants, the transactions between onshore and offshore participants may not have been included in the statistics. That is, they disclose partial information involving only some of the participants (mainly overseas participants), not the whole data on True Outstanding Loans directly related to short selling.

Also, the short interest disclosed by those systems differs significantly from the True Short Interest since the figure indicates simple loans or balance of the loans rather than what's actually traded as a short sale.

As explained so far, none of the methods above provide accurate information on True Outstanding Loan, True Borrow Cost, True Borrow Utilization, True Short Interest that indicates all relevant transactions with the same effect as short selling, True Days to Cover, True Availability of the securities that is a reflection of what can actually be lent, True Recall and True Rate Change, True Outstanding Swaps & Transactions, True Locate Approvals, True Collateral Pledged and True Intermediary Transactions Summary. Thus, there is a need for the technology that can provide this information.

### Details of the Invention

### Technological Objective

This invention aims to resolve problems of the existing technology system as aforementioned.

This invention also aims to provide accurate information on LBT or short selling such as True Outstanding Loan (including the amount of excess borrow which has not been shorted yet), True Borrow Cost, True Borrow Utilization, True Short Interest, True Days to Cover and True Availability, which indicates the amount that can actually be lent and borrowed.

### Development Measures

Core structure of this invention to meet the purposes is as follows.

One form of this invention offers a method to provide information on LBT or short sell transactions, which can be implemented through a system providing data on LBT, short sell or equity swap transactions, that includes raw data processing unit and information creation unit: the process includes (a) a step for the raw data processing unit to acquire raw data on securities for LBT, short sale or equity swap transactions, (b) a step for the raw data processing unit to transform acquired raw data into a pre-determined format and save into database and (c) a step to generate information through information creation unit, which include at least one of following data—True Outstanding Loan, True Borrow Cost, True Utilization, True Short Interest, True Days to Cover and True Availability—based on database mentioned above. The True Outstanding Loan is determined with reference to at least one of the following data: outstanding amount of short sale transactions excluding equity swap, excess borrow for short selling excluding for equity swap transactions, outstanding amount short sold for hedging equity short swap, outstanding amount long sold for hedging equity short swap, ‘pay-to-hold’ (PTH) amount to be used for shorting selling through equity swap, short sales directly executed by hedge funds without using equity swaps, and excess borrow secured by hedge funds without using equity swap. The True Borrow Cost (or rate) is determined with reference to at least one of the following data's average borrow rate: what's lent from securities companies' net assets; what's lent from the institutional lenders; what's lent from the onshore/offshore retail pools; what's lent from the pension funds; what's lent from onshore/offshore assets for hedging derivatives; what's lent from the hedge funds' assets; and/or what's lent from assets for hedging ETFs. The True Short Interest is determined with reference to aggregated figures of the following: outstanding amount short sold excluding equity swap transactions; outstanding amount short sold for hedging equity short swap; outstanding amount long sold for hedging equity short swap; and outstanding short sales executed by hedge funds without using equity swap. The True Days to Cover is determined with reference to True Short Interest divided by average daily trading volume for the pre-determined period. The True Availability is determined with reference to aggregated figures of at least one of the following: securities companies' net long assets, institutional lenders' assets, onshore/offshore retail pools, pension fund assets, assets used for hedging derivatives, assets held by hedge funds, and assets used for hedging ETFs. The True Borrow Utilization is determined with reference to True Outstanding Loan divided by True Availability.

Another form of this invention offers a system that provides information on LBT, short sell, or equity swap transactions: the raw data processing unit that acquires raw data on LBT, short sell, or equity swap transactions from at least one of the user terminals, which will be transformed in accordance with the predetermined format and saved in the database; information creation unit that, by utilizing the information obtained by the raw data processing unit, generates at least one of the following information: True Outstanding Loan, True Borrow Cost, True Utilization, True Short Interest, True Days to Cover, or True Availability; The True Outstanding Loan is determined with reference to at least one of the following data: outstanding amount of short sale transactions excluding equity swap, excess borrow for short selling excluding for equity swap transactions, outstanding amount short sold for hedging equity short swap, outstanding amount long sold for hedging equity short swap, ‘pay-to-hold’ (PTH) amount to be used for shorting selling through equity swap, short sales directly executed by hedge funds without using equity swaps, and excess borrow secured by hedge funds without using equity swap. The True Borrow Cost (or rate) is determined with reference to at least one of the following data's average borrow rate: what's lent from securities companies' net assets; what's lent from the institutional lenders; what's lent from the onshore/offshore retail pools; what's lent from the pension funds; what's lent from onshore/offshore assets for hedging derivatives; what's lent from the hedge funds' assets; and/or what's lent from assets for hedging ETFs. The True Short Interest is determined with reference to aggregated figures of the following: outstanding amount short sold excluding equity swap transactions; outstanding amount short sold for hedging equity short swap; outstanding amount long sold for hedging equity short swap; and outstanding short sales executed by hedge funds without using equity swap. The True Days to Cover is determined with reference to True Short Interest divided by average daily trading volume for the pre-determined period. The True Availability is determined with reference to aggregated figures of at least one of the following: securities companies' net long assets, institutional lenders' assets, onshore/offshore retail pools, pension fund assets, assets used for hedging derivatives, assets held by hedge funds, and assets used for hedging ETFs. The True Borrow Utilization is determined with reference to True Outstanding Loan divided by True Availability.

In addition, other methods to implement this invention as well as a computer-readable recording medium for recording computer programs that implements the system and the methods aforementioned are provided.

### Effect of this Invention

According to this invention, because accurate information on True Outstanding Loans including excess borrows that are not shorted yet, True Borrow Cost, True Borrow Utilization, True Short Interest including the transactions having same effect as short selling, True Days to Cover, True Availability for LBTs, can be provided and updated through this system, it improves the transparency of the market as well as activate sharing of the information on LBTs between onshore and offshore transactions so that the participants of the LBTs do not make incorrect decisions due to the information inequality.

### DESCRIPTION OF DIAGRAM

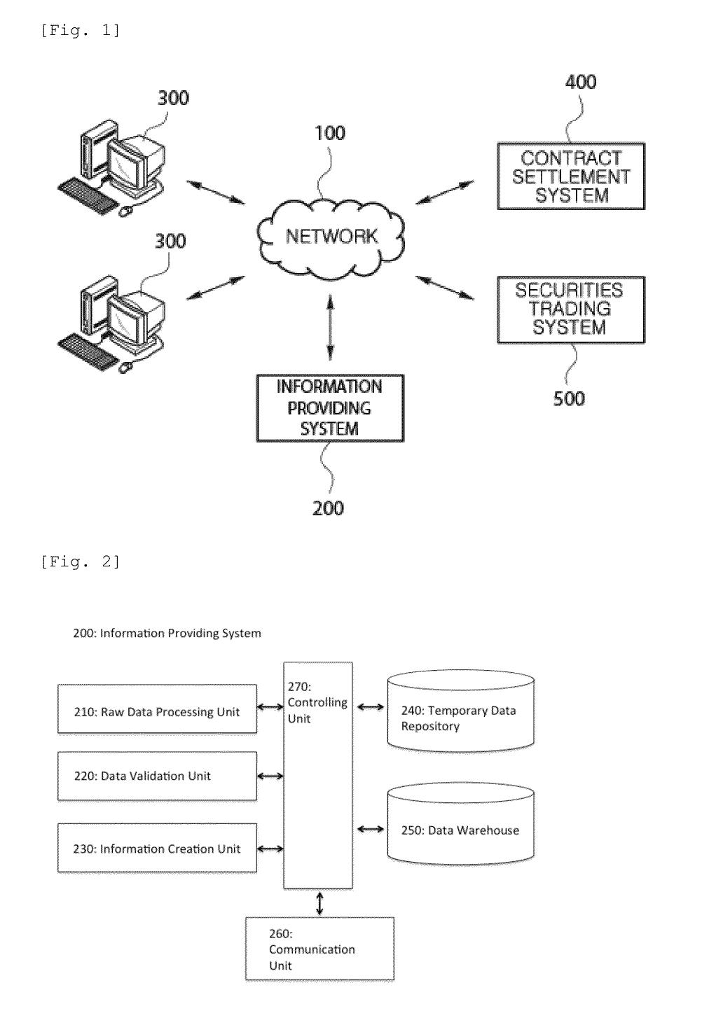

FIG. 1 depicts overall structure of the whole system that provides information on LBT and short sale transactions.

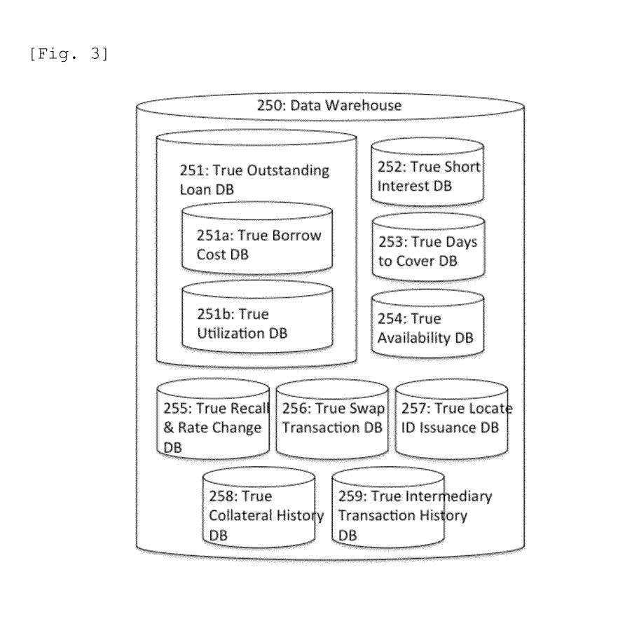

FIGS. 2 and 3 specifically depict the internal structure of information providing system (200) in accordance with the illustrative implementation of the invention.

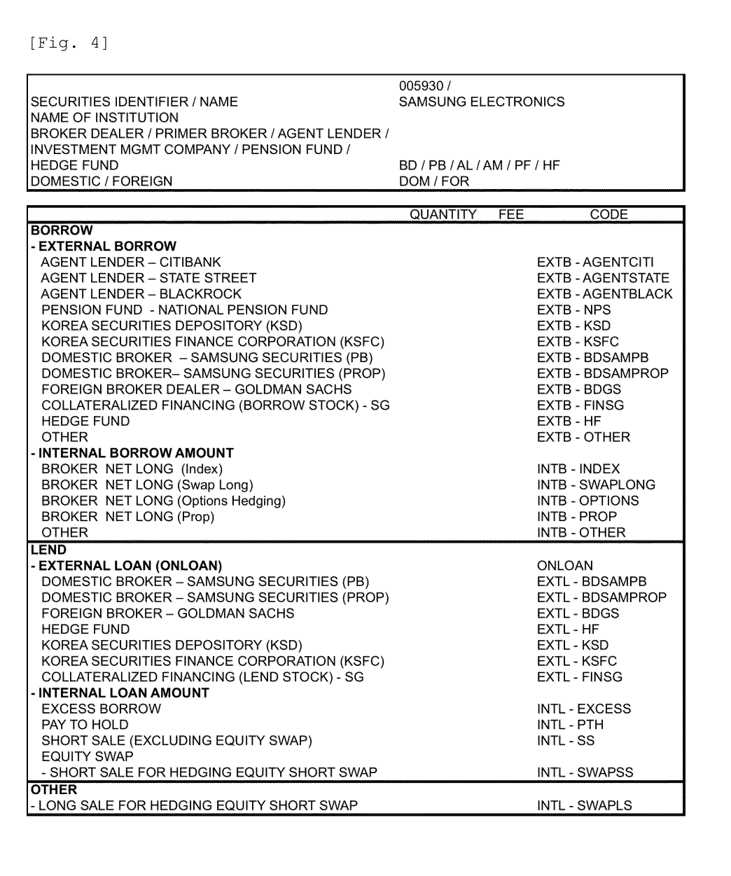

FIGS. 4, 5 and 12 illustrates the structure of raw data transformed into predetermined format in accordance with the illustrative implementation of the invention.

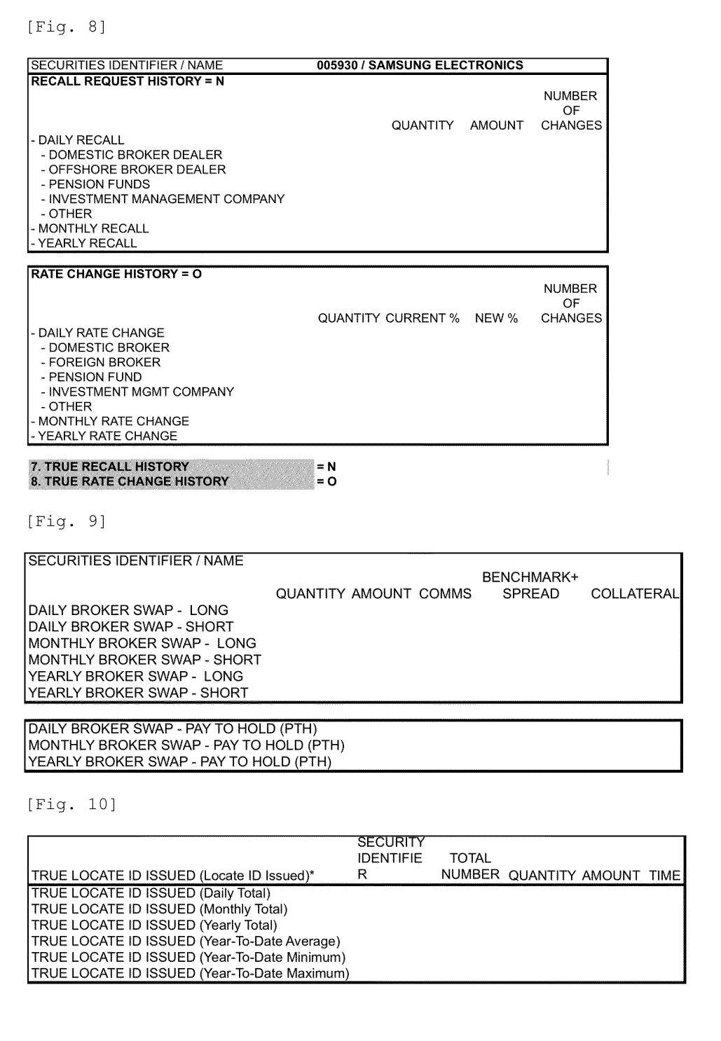

Each of FIGS. 6 through 11 illustrates information on True Outstanding Loan, True Borrow Cost, True Borrow Utilization, True Short Interest, True Days to Cover, True Availability, True Recall and True Rate Change, True Outstanding Swaps & Transactions, True Locate Approvals, True Collateral Pledged and True Intermediary Transactions Summary, in accordance with the illustrative implementation of the invention.

### DESCRIPTION OF NUMBERS

100: Network
200: Information Providing System
210: Raw Data Processing Unit
220: Data Validation Unit
230: Information Creation Unit
240: Temporary Data Repository
250: Data Warehouse
251: True Outstanding Loan Database
251a: True Borrow Cost Database
251b: True Utilization Database
252: True Short Interest Database
253: True Days to Cover Database
254: True Availability Database
255: True Recall & Rate Change Database
256: True Swap Transaction Database
257: True Locate ID Issuance Database
258: True Collateral History Database
259: True Intermediary Transaction History Database
260: Communication Unit
270: Controlling Unit
300: User Terminal Device
400: Contract Settlement System
500: Securities Trading System

### Examples of Implementation of the Invention

Explanations on the invention detailed as follows are illustrative implementation examples of the invention, which shall be referred to the figures depicting the processes or structures. These illustrative implementations shall be explained in sufficient details so as skilled persons can implement. Illustrative implementation examples of this invention may be different but not necessarily mutually exclusive. For instance, the forms, structure or features recorded in this Specification can be realized by transforming one implementation example to another implementation example as long as they are in the spirit and scope of the invention. Also, it needs to be understood that location or configuration of the components for each illustrative example may be changed as long as it is in the spirit and scope of this invention. Accordingly, following detailed explanations are not presented to limit the implementation and thus the scope of this invention is considered to cover the scope claimed and the entire scope equivalent to the scope claimed. The Numbers shown in Diagrams represents the same or similar components in many aspects.

Explanations on the invention detailed as follows are illustrative implementation examples of the invention aiming at enabling a person with reasonable knowledge in technology to implement this invention, which will be referred to the figures attached.

### Desirable Implementation Examples of this Invention

Securities under this Specification refer to a certificate that expresses rights to demand certain amount of money or certain assets with value, indicating any right in property in accordance with the Commercial Act. The meaning of securities under his Specification does not limit the meaning under the Commercial Act or Securities or Exchange Act. The term “securities” here is interpreted most widely and thus refers to all kinds of assets that can be the subject of LBT. For instance, this Specification refers to listed stocks, unlisted stocks, bonds, beneficiary certificates, pre-emptive rights, financial products including beneficiary certificates, futures, derivatives including equity swaps, equity-linked securities, equity-linked warrants, bonds with warrants, convertible bonds, exchange traded funds as securities.

Structure of the Whole System

FIG. 1 depicts overall structure of the whole system that assists LBT and short sell transactions in accordance with the invention.

As FIG. 1 has depicted, the whole system in accordance with the implementation example of this invention may be composed of Network (100), Information Providing System (200), User Terminal Device (300), Contract Settlement System (400), Securities Trading System (500).

First of all, network of this invention can be established through wire or wireless communication network and may be composed of various networks such as LAN (Local Area Network), MAN (Metropolitan Area Network) or WAN (Wide Area Network). Desirably, the Network (100) in this Specification may refer to Internet or World Wide Web (WWW). However, the Network (100) is not confined to those and at least a part of the network may include wire/wireless data communication network, telephone network or wire/wireless television network. Meanwhile, Network (100) may, in some cases, include dedicated circuit (not in the Figures) of the securities exchange or that of a securities company.

Next, Information Providing System (200) acquires, transforms and validates raw data on LBT or short sale transactions from a user's terminal device (300) and, based on the data obtained through this process, it can implement the function to provide (and disclose) information on true outstanding loan, true borrow cost, true borrow utilization, true short interest including transactions with the same effect as short selling, true days to cover, true availability of the securities that can practically be lent, true recall and true rate change, true outstanding swaps & transactions, true locate approvals, true collateral pledged and true intermediary transactions summary.

The details on composition of the Information Providing System (200) in accordance with this invention will be discussed in the later part (Composition of Information Providing System).

Next, user terminal device (300) shown in the illustration is a device that enables connection to the Information Providing System (200), which transmits the raw data inputted by the user (participant of the transaction) to the Information Providing System (200) and also can perform the function to provide various information on LBT or short selling obtained from the Information Providing System (200).

Meanwhile, user terminal device (300) shown in the illustration is digital appliance that can communicate through the Network (100) by connecting to it, which includes smart phones, PDAs, personal computers (e.g. desktop, laptop, etc.), web pads, mobile phones—the device equipped with memory and micro-processor and thus containing calculation function may be used as the said devices (300) in this invention. Also, It may be necessary to include programs such as application, web browser, widget in a user terminal device (300) shown in the illustration, in order to enable a borrower or a lender to exchange various types of information through the Information Providing System (200).

Next, in accordance with an illustrative implementation of this invention, Contract Settlement System (400) actually settles LBT contracts between borrowers and lenders upon the receipt of the transmitted information that the LBT between the users (that is, participants of the transaction) was confirmed. For instance, this Contract Settlement System (400) in accordance with an illustrative implementation of this invention could be a system operated by LBT intermediaries, securities companies, or stock exchanges.

Next, Securities Trading System (500) in accordance with an illustrative implementation of this invention conducts a function to order short selling of borrowed securities upon the receipt of the transmitted information that the LBT between the users (that is, participants of the transaction) was confirmed or that the LBT contract was settled by the Contract Settlement System (400). For instance, this Securities Trading System (500) in accordance with an illustrative implementation of this invention could be a system operated by stock exchanges or securities companies.

Composition of Information Providing System

This part explains internal composition and the function of each element of Information Providing System (200) in accordance with the implementation of the invention.

FIGS. 2 and 3 specifically depict the internal composition of Information Providing System (200) in accordance with the illustrative implementation of the invention.

As shown in FIGS. 2 and 3, Information Providing System (200) in accordance with the illustrative implementation of the invention may be composed of Raw Data Procession Unit (210), Data Validation Unit (220), Information Creation Unit (230), Temporary Data Repository (240), Data Warehouse (250), Communication Unit (260) and Controlling Unit (270). Here, Data Warehouse (250) may be composed of True Outstanding Loan Database (251), True Borrow Cost Database (251A), True Utilization Database (251B), True Short Interest Database (252), True Days to Cover Database (253), True Availability Database (254), True Recall & Rate Change Database (255), True Swap Transaction Database (256), True Locate ID Issuance Database (257), True Collateral History Database (258) and True Intermediary Transaction History Database (259). At least some of the components of the Information Providing System (200), in accordance with the illustrative implementation of the invention, including Raw Data Procession Unit (210), Data Validation Unit (220), Information Creation Unit (230), Temporary Data Repository (240), Data Warehouse (250), Communication Unit (260) and Controlling Unit (270), may be program modules that communicate with User Terminal Device (300), Contract Settlement System (400) or Securities Trading System (500). These program modules can be contained in Information Providing System (200) in the form of operating system, application program module or other program modules, and can physically be saved in various publicly-noticed memory devices. Also, this program module can be saved in a remote-controlled memory device that can communicate with Information Providing System (200). Meanwhile, this program module include routine, explained in a later part (which performs certain function or implements certain abstract data types), sub-routine, program, object, component and data structure, but does not confine itself to the said modules.

Firstly, in accordance with the illustrative implementation of the invention, Raw Data Processing Unit (210) can perform a function to acquire raw data on LBT, short selling or equity swap transactions from user terminal devices (300). As will be explained in a later part, the raw data acquired from the system, can be utilized as basis data for creating various information on LBT, short selling or equity swap transactions.

Specifically, in accordance with the illustrative implementation of the invention, raw data in various methods and forms can be transmitted from user terminal devices (300) to Raw Data Procession Unit (210). For instance, raw data could be transmitted using various protocols such as FTP (File Transfer Protocol), SFTP (Secure File Transfer Protocol or SSH File Transfer Protocol), FIX (Financial Information eXchange) in the form of direct input of the data in the specified sections of the raw data, text file or in XML (eXtensible Markup Language) file.

Also, in accordance with the illustrative implementation of the invention, Raw Data Processing Unit (210) can play a role in unifying various forms of raw data acquired from many user terminal devices (300) by transforming the raw data into a predetermined format.

FIGS. 4, 5 and 12 in accordance with the illustrative implementation of the invention, illustrate configuration of the raw data transformed into pre-determined format.

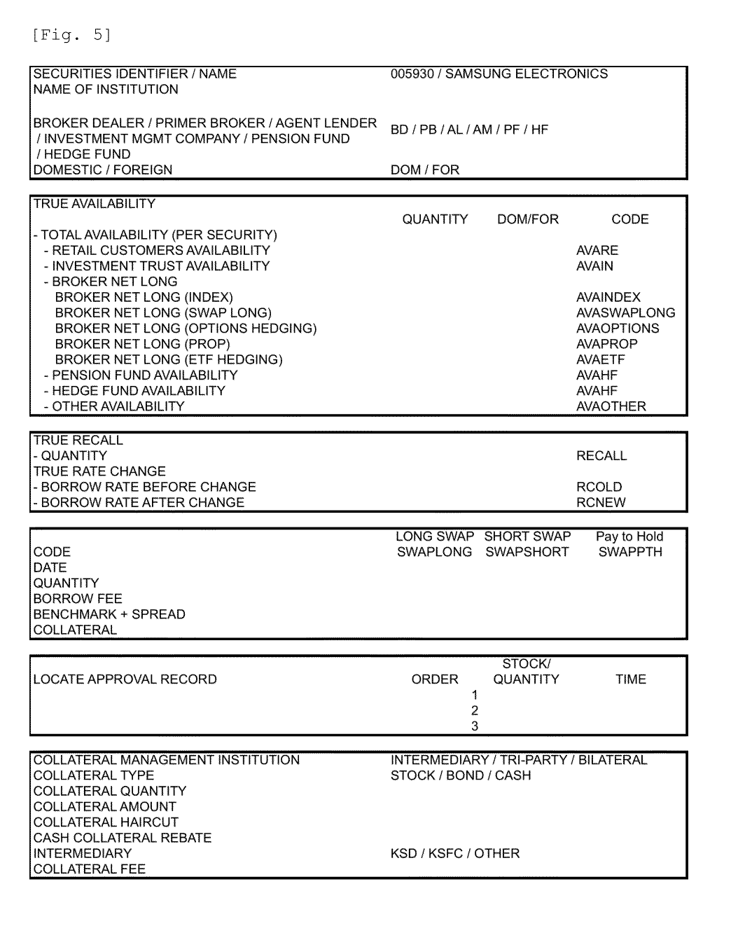

With reference to FIGS. 4 and 5, the raw data in accordance with the illustrative implementation of the invention, can be composed of at least one of the items each of which was assigned a predetermined code. For instance, the raw data may include unique identification data (or code) on LBT, short selling and equity swap transactions as well as information necessary for calculating true outstanding loan (including true borrow rate, true borrow utilization and collateral provision history), information necessary for calculating true short interest (including true days to cover), information necessary for calculating true availability and information necessary for calculating true recall & true rate change, true outstanding swaps & transactions, true locate approvals and true intermediary transactions summary, and unique code for each item may be assigned to at least one of the items constituting the raw data.

Also, in reference to FIG. 12, raw data in accordance with the implementation examples can be composed of information on stock names, parties, LBT, on-lent amount, short selling and equity swap, and true availability.

However, the composition of the raw data is not limited to the information aforementioned and can be changed as long as it is within the purpose of this invention, for the record.

Next, in accordance with the implementation examples of the invention, Data Validation Unit (220) can conduct a function to temporarily save the data transformed as aforementioned in the Temporary Data Repository (240) (that is, temporary database). As will be explained in a later part, the data saved in the Temporary Data Repository (240) will go through data validation process and as a result only the validated data will be saved in the Data Warehouse (250) and utilized as basis for generating information on LBT, short selling or equity swap transactions.

Also, in accordance with the implementation examples of the invention, Data Validation Unit (220) validates whether the data transformed through the Raw Data Processing Unit (210) have validity so that they can be used as a basis for generating information on LBT, short selling or equity swap transactions, and as a result conducts a function to save the valid data in the Data Warehouse (250). Consequently, Data Validation Unit (220) can prevent inaccuracy in information generated due to false or invalid data.

More specifically, Data Validation Unit (220) in accordance with the implementation examples of the invention, can gauge whether the data under the validation test overlap with the data already validated and saved in the Data Warehouse (250) as well as whether the data under the validation test comply with the predetermined rules.

For instance, the Data Validation Unit (220) in accordance with the implementation examples of the invention, can decide the data as valid only if the data meets the following criteria.

<Rule 1>

For each stock,

(external borrow)=(external loan)

and also

(collateralized financing transaction (securities borrowed))=(collateralized financing transaction (securities lent))

should be satisfied.

<Rule 2>

For each stock,

(external borrow amount)+(collateralized financing transaction (securities borrowed))≦(Total LBT trading volume per each stock)

or

(External loan amount)+(collateralized financing transaction (securities lent))≦(Total LBT trading volume per each stock)

should be satisfied.

<Rule 3>

For each stock,

((External borrow amount)+(net assets))(=internal loanable amount)≧(external loan amount (Onloan))

should be satisfied.

<Rule 4>

For each stock,

(net asset balance in case of net short)≧{(−1)×((short selling balance)+(short/long sale for hedging equity short swap)}

(Here, (Net assets(End of the Day))=(Net assets (Beginning of the Day))+(daily purchase)−(daily short sale)−(daily long sale))

should be satisfied.

<Rule 5>

For each stock,

(Total loans)=(Broker dealer internal long loans)+(retail pool loans)+(institution loans)+(pension fund loans)+(other loans)

and

(Total Borrow)=(short sale excluding equity swap)+(excess borrow for short selling)+(short sale for hedging equity swap)+(pay to hold for equity short swap)+(External loans (On Loan))+(other loans)

should be satisfied.

<Rule 6>

For each stock,

(Total availability)=(broker dealer internal long availability)+(retail customers availability)+(institution availability)+(pension fund availability)+(other availability)

should be satisfied.

<Rule 7>

For each stock,

(Total short sale volume disclosed by securities exchange)=(daily short sale trading volume)+(daily trading volume of short sale for hedging equity short swap)

should be satisfied.

<Rule 8>

For each stock,

(Total stock available for LBT)≦(Floating shares excluding strategic holding (that is, securities that are held by executives or other corporations making them difficult to be lent or borrowed))

should be satisfied (Here, criteria for determining whether it is strategic holding can be changed).

<Rule 9>

For each stock,

(Daily recall)≦(daily LBT balance)

should be satisfied.

<Rule 10>

For each stock,

(Daily return)≦(daily LBT balance)

should be satisfied.

<Rule 11>

For each stock,

(True utilization)=(true outstanding loan/true availability)

should be satisfied.

<Rule 12>

For each stock,

(True days to cover)=(True short interest)/(daily average volume)

should be satisfied. (Here, daily average volume can be calculated based on the average volume for a period—for instance, 7 days, 20 days or 30 days.

In spite of the rules listed above, the validation methods of the Data Validation Unit (220) are not confined to those described in the listed rules, and can be modified as long as the method is within the range of the spirit of accomplishing the purpose of the invention. Meanwhile, only the implementation examples of conducting the validation of the data saved in the Temporary Data Repository (240) are described up to now, the contents of this invention are not limited to these implementation examples, and the Data Validation Unit (220) can conduct the validation before or after the data are saved in the Temporary Data Repository (240).

Next, in accordance with the implementation examples of the invention, Information Creation Unit (230) can perform a function to create and provide (that is, disclose) various information on LBT or short selling based on the valid data saved in Data Warehouse (250). Specifically, Information Creation Unit (230) in accordance with the implementation examples of the invention can conduct a function to create information on true outstanding loan, true borrow cost, true borrow utilization, true short interest, true days to cover, true availability, true recall & true rate change, true outstanding swaps & transactions, true locate approvals, true collateral pledged and true intermediary transactions summary.

FIGS. 6 through 11 exemplify the configuration of the variety of information on securities, which was provided in accordance with the implementation of the invention.

First of all, with reference to FIG. 6, information on true outstanding loan, true borrow cost, true borrow utilization, true short interest and true days to cover of Samsung Electronics (Identification No. 005930) shares can be provided.

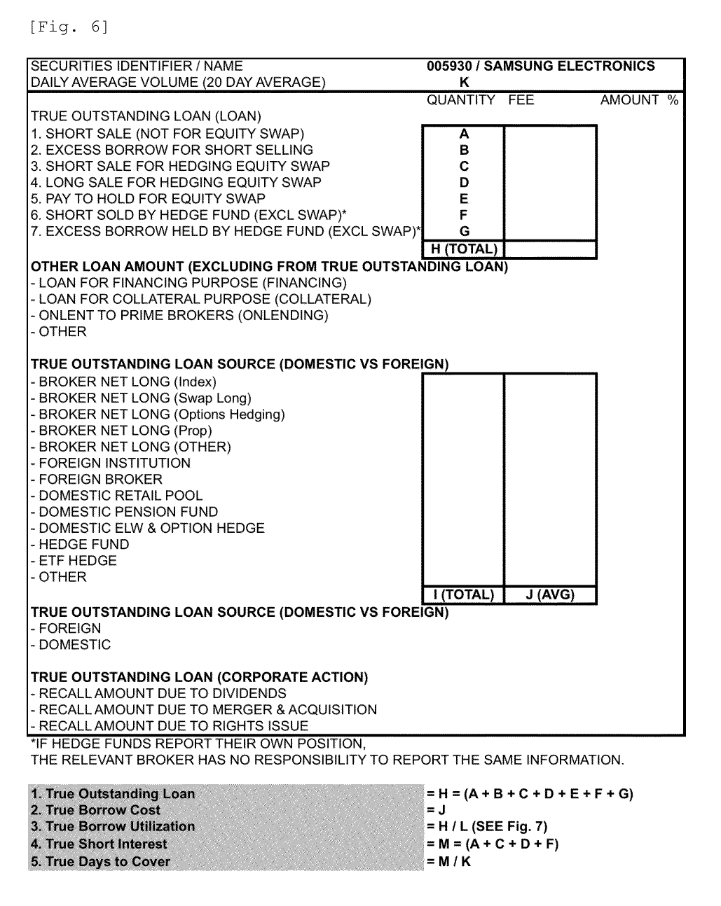

Next, with reference to FIG. 7, information on true availability of Samsung Electronics (Identification No. 005930) shares can be provided.

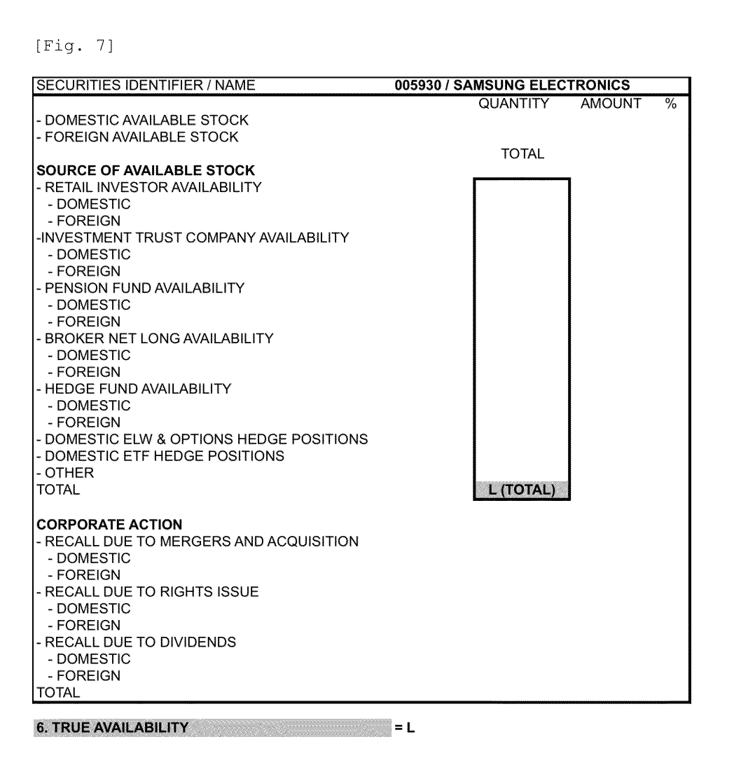

Next, with reference to FIG. 8, information on true recall & true rate change of Samsung Electronics (Identification No. 005930) shares can be provided.

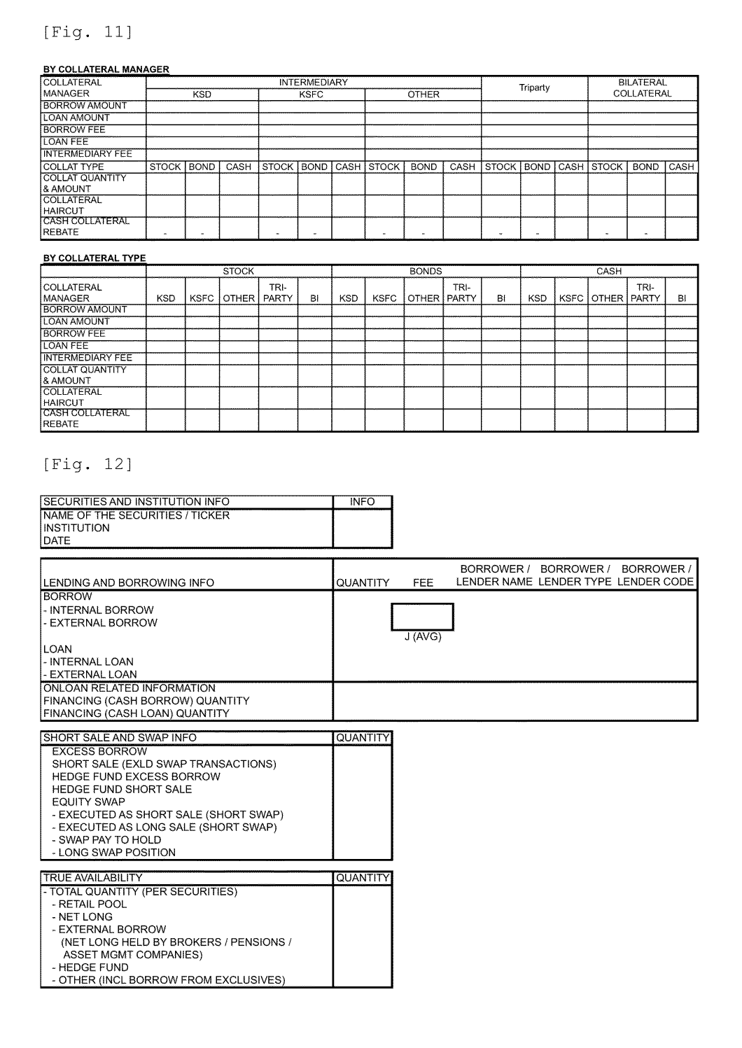

Next, with reference to FIGS. 9 and 11, information on true outstanding swaps & transactions, true locate approvals, true collateral pledged and true intermediary transactions summary of Samsung Electronics (Identification No. 005930) shares can be provided.

Meanwhile, in accordance with the implementation examples of the invention, a user can be provided customized information by inputting queries on period, users, items in his/her terminal device (300) as well as by setting certain conditions that should be met before the information is sent to the user.

Operating data repository (that is Temporary Data Repository (240)) in accordance with the implementation examples of the invention may contain raw data or the transformation of the raw data acquired from the user terminal device (300), temporarily saved in the repository. Meanwhile, the Temporary Data Repository (240) of this invention includes computer-readable recording medium, which may contain the database in the broad sense (which is based on file system) in addition to the database in the narrow sense: it can be the Temporary Data Repository (240) of this invention, even if it is merely a simple log set, if the data can be retrieved and extracted.

Variety of information acquired, created, modified and managed by Information Providing System (200) can be stored in Data Warehouse (250) (that is, database) in accordance with the implementation examples of the invention. Data Warehouse (250) in accordance with the implementation examples of the invention, may contain True Outstanding Loan Database (251), True Borrow Cost Database (251a), True Utilization Database (251b), True Short Interest Database (252), True Days to Cover Database (253), True Availability Database (254), True Recall & Rate Change Database (255), True Swap Transaction Database (256), True Locate ID Issuance Database (257), True Collateral History Database (258) and True Intermediary Transaction History Database (259), of which the classification depends on what kind of information the database holds. Although the Data Warehouse (250) is depicted in FIG. 2 as a component of the Information Providing System (200), the Data Warehouse (250) and the Information Providing System (200) may be separated at the discretion of a person responsible for implementing the invention, as necessary. Meanwhile, the Data Warehouse (250) of this invention includes computer-readable recording medium, which may contain the database which may contain the database in the broad sense—including data records based on file system, as well as the database in the narrow sense: it can be the Data Warehouse (250) of this invention, even if it is merely a simple log set, if the data can be retrieved and extracted.

Next, Communication Unit (260) in accordance with the implementation examples of the invention can conduct a function to facilitate the data transmission/receipt to or from Raw Data Processing Unit (210), Data Validation Unit (220), Information Creation Unit (230), Temporary Data Repository (240) and Data Warehouse (250).

Lastly, the Controlling Unit (270) in accordance with the implementation examples of the invention can conduct a function to control the flow of the data among Raw Data Processing Unit (210), Data Validation Unit (220), Information Creation Unit (230), Temporary Data Repository (240), Data Warehouse (250) and Communication Unit (260). That is, the Controlling Unit (270) of this invention can, by controlling the flow of the data from or to the outside or the flow between the Information Providing System (200) and each component, control Raw Data Processing Unit (210), Data Validation Unit (220), Information Creation Unit (230), Temporary Data Repository (240), Data Warehouse (250) and Communication Unit (260) perform their individual functions.

The implementation examples in accordance with the invention as explained so far can be realized in the form of programming language implementable through various computer components and recorded in the non-transitory computer-readable recording medium. The computer-readable recording medium can include programming instruction code, data file, data structure, etc., individually or in combination. The programming instruction code recorded in the computer-readable recording medium may be specifically planned or structured for this invention or may be usable in accordance with the notice to the computer or software personnel. Examples of computer-readable recording media include hard disk, floppy disk, magnetic medium such as hard disc, floppy disk, magnetic disc or magnetic tape, optical recording channel medium such as CD-ROM or DVD, magneto-optical medium such as floptical disk, and a hardware device specifically structured to save and implement the programming instruction code such as ROM, RAM or flash memory. An example of the programming instruction code include machine language (or code) created by compiler as well as advanced language code that can be implemented by Interpreter via computer. Hardware devices may be transformed into one or more software modules, or the other way around, in order to conduct processes in accordance with this invention.

This invention was explained in terms of certain aspects such as specific components, and limited implementation examples and figure, which were provided in order to assist general understanding of his invention, but not to limit the invention to those implementation invention, and thus a person with reasonable knowledge in the technological area to which this invention belongs may seek to modify or transform the examples introduced.

Thus, realization of this invention should not be confined to the implementation examples explained above, and scope of claims of patent right as well as all of the scope considered to be uniformly or equivalently transformed scope may be within the scope of this invention.

1. The method, implemented in the information providing system for providing information on loan transaction, short sell transaction or equity swap transaction, which consists of raw data processing unit and information creation unit, includes the steps as follows:
(a) the abovementioned raw data processing unit acquires raw data related to loan transaction, short sell transaction or equity swap transaction from at least one of the user terminal devices;
(b) the abovementioned raw data processing unit transforms the raw data acquired in step (a) into a pre-determined format and saves it to database; and
(c) the abovementioned information creation unit then generates information on at least one of True Outstanding Loan, True Borrow Cost, True Utilization, True Short Interest, True Days to Cover, True Availability based on the data saved in the abovementioned database.
WHEREIN:
the True Outstanding Loan is determined by referencing the aggregate of at least one of the figures of the outstanding position executed as a short sell (excluding equity swap transactions), the excess borrow to be used for short selling (excluding excess borrow for equity swap), the outstanding position executed as a short sell for hedging equity short swap, the outstanding position executed as a long sell for hedging equity short swap, pay to hold positions for equity swap transactions, outstanding position executed as a short sell by hedge funds (excluding equity swap transactions) and the excess borrow held by hedge fund (excluding pay to hold position for equity swap);
the True Borrow Cost is determined by referencing the average lending and borrowing transaction (LBT) cost of at least one of the figures of the loan from the broker-dealer's net long positions, the loan from foreign/domestic institutions, the loan from foreign/domestic retail pools, the loan from foreign/domestic pension funds, the loan from the position used to hedge foreign/domestic derivatives products, the loan from hedge fund's long position, and the loan from the position used to hedge ETFs;
the True Short Interest is determined by referencing the aggregate of the figures of the outstanding position executed as a short sale (excluding equity swap transactions), the outstanding position executed as a short sell for hedging equity short swap, the outstanding position executed as a long sell for hedging equity short swap, and the outstanding position executed as a short sell by hedge fund (excluding equity swap transactions);
the True Days to Cover is determined by referencing the figure of true short interest divided by daily average trading volume for a pre-determined period;
the True Availability is determined by referencing the aggregate of at least one of the figures of the internal net long position held by the broker-dealers, the position held by foreign/domestic institutions, the position held in foreign/domestic retail pools, the position held by foreign/domestic pension funds, the position used to hedge foreign/domestic derivatives products, the long position held by hedge funds, and the position used to hedge ETFs; and
the True Utilization is determined by referencing the figure of the True Outstanding Loan divided by the True Availability.

2. The method of claim 1, wherein the securities include at least one of the following: listed stocks, unlisted stocks, bonds, beneficiary certificates, preemptive rights, financial instruments including beneficiary certificates, futures, financial derivatives including equity swap, equity-linked securities (ELSs), equity-linked warrants (ELWs), bonds with warrants (BW), convertible bonds (CBs), and exchange traded funds (ETFs).

3. The method of claim 1, wherein the transformed data in the system include at least one of the items each of which was assigned a pre-determined code.

4. The method of claim 1 in the step (b), wherein the data validation unit examines whether the transformed data overlap with other data saved in the database.

5. The method of claim 1, wherein the raw data processing unit periodically implements the steps (a) and (b) whenever the pre-determined time lapses.

6. The non-transitory computer-readable recording medium that records computer program implementing a method in accordance with claim 1.

7. The system for providing information on loan transaction, short sell transaction or equity swap transaction, wherein the raw data processing unit obtains raw data on securities for loan transaction, short sell transaction or equity swap transaction from at least one user terminal device and transforms the raw data into pre-determined format and saves them in database, as well as the information creation unit which, based on the data saved in the abovementioned database, generates at least one of following information—True Outstanding Loan, True Borrow Cost, True Utilization, True Short Interest, True Days to Cover and True Availability:
the True Outstanding Loan is determined by referencing the aggregate of at least one of the figures of the outstanding position executed as a short sell (excluding equity swap transactions), the excess borrow to be used for short selling (excluding excess borrow for equity swap), the outstanding position executed as a short sell for hedging equity short swap, the outstanding position executed as a long sell for hedging equity short swap, pay to hold positions for equity swap transactions, outstanding position executed as a short sell by hedge funds (excluding equity swap transactions) and the excess borrow held by hedge fund (excluding pay to hold position for equity swap);
the True Borrow Cost is determined by referencing the average lending and borrowing transaction (LBT) cost of at least one of the figures of the loan from the broker-dealer's net long positions, the loan from foreign/domestic institutions, the loan from foreign/domestic retail pools, the loan from foreign/domestic pension funds, the loan from the position used to hedge foreign/domestic derivatives products, the loan from hedge fund's long position, and the loan from the position used to hedge ETFs;
the True Short Interest is determined by referencing the aggregate of the figures of the outstanding position executed as a short sale (excluding equity swap transactions), the outstanding position executed as a short sell for hedging equity short swap, the outstanding position executed as a long sell for hedging equity short swap, and the outstanding position executed as a short sell by hedge fund (excluding equity swap transactions);
the True Days to Cover is determined by referencing the figure of true short interest divided by daily average trading volume for a pre-determined period;
the True Availability is determined by referencing the aggregate of at least one of the figures of the internal net long position held by the broker-dealers, the position held by foreign/domestic institutions, the position held in foreign/domestic retail pools, the position held by foreign/domestic pension funds, the position used to hedge foreign/domestic derivatives products, the long position held by hedge funds, and the position used to hedge ETFs; and
the True Utilization is determined by referencing the figure of the True Outstanding Loan divided by the True Availability.

8. The system under the claim 7, wherein the securities include at least one of the following: listed stocks, unlisted stocks, bonds, beneficiary certificates, preemptive rights, financial instruments including beneficiary certificates, futures, financial derivatives including equity swap, equity-linked securities (ELSs), equity-linked warrants (ELWs), bonds with warrants (BW), convertible bonds (CBs), and exchange traded funds (ETFs).

9. The system under the claim 7, wherein the transformed data in the system include at least one of the items each of which was assigned a pre-determined code.

10. The system under the claim 7, wherein the data validation unit examines whether the transformed data overlap with other data saved in the database.

11. The system under the claim 7, wherein the raw data processing unit periodically operates whenever the pre-determined time lapses.

12. The non-transitory computer-readable recording medium that records computer program implementing a method in accordance with claim 2.

13. The non-transitory computer-readable recording medium that records computer program implementing a method in accordance with claim 3.

14. The non-transitory computer-readable recording medium that records computer program implementing a method in accordance with claim 4.

15. The non-transitory computer-readable recording medium that records computer program implementing a method in accordance with claim 5.
